(19) United States
(12) Patent Application Publication
(10) Pub. No.: US 2008/0257794 A1
(43) Pub. Date: Oct. 23, 2008

(54) Method and system for sorting and processing recycled materials

(76) Inventor: Thomas A. Valerio, Stone Mountain, GA (US)

Correspondence Address: KING & SPALDING LLP, 1180 PEACHTREE STREET, ATLANTA, GA, 30309-3521, US

(21) Appl. No.: 12/148,520

(22) Filed: Apr. 18, 2008

Related U.S. Application Data
(60) Provisional application No. 60/925,051, filed on Apr. 18, 2007.

(51) Int. Cl. B07C 5/344; B03B 5/70; B07C 5/342

(52) U.S. Cl. 209/567; 209/155; 209/576; 209/172

(57) ABSTRACT

Processing recycled materials to recover plastics, copper wire, and other non-ferrous metals. Aspects of the invention employ density separation to separate plastic-bearing materials from copper-bearing materials. Plastic-bearing materials are further separated to separate light plastics from heavy plastics. Plastics are concentrated, extruded, and palletized. Copper and other valuable metals are recovered from copper-bearing materials using a water separation table.

### STATEMENT OF RELATED PATENT APPLICATIONS

This non-provisional patent application claims priority under 35 U.S.C. § 119 to U.S. Provisional Patent Application No. 60/925,051, entitled Method and System for Sorting and Processing Recycled Materials, filed Apr. 18, 2007. This provisional application is hereby fully incorporated herein by reference.

### FIELD OF THE INVENTION

This invention relates to recovering materials from a waste material stream. More particularly, this invention relates to identifying and recovering plastics and non-ferrous metals, including copper wiring, from a recycle waste stream containing dissimilar materials.

### BACKGROUND OF THE INVENTION

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Typically, waste streams are composed of a variety of types of waste materials. One such waste stream is generated from the recovery and recycling of automobiles or other large machinery and appliances. For examples, at the end of its useful life, an automobile is shredded. This shredded material is processed to recover ferrous and non-ferrous metals. The remaining materials, referred to as automobile shredder residue (ASR), which may still include ferrous and non-ferrous metals, including copper wire and other recyclable materials, is typically disposed of in a landfill. Recently, efforts have been made to further recover materials, such as non-ferrous metals including copper from copper wiring and plastics. Similar efforts have been made to recover materials from whitegood shredder residue (WSR), which are the waste materials left over after recovering ferrous metals from shredded machinery or large appliances. Other waste streams that have recoverable materials may include electronic components, building components, retrieved landfill material, or other industrial waste streams. These recoverable materials are generally of value only when they have been separated into like-type materials. However, in many instances, no cost-effective methods are available to effectively sort waste materials that contain diverse materials. This deficiency has been particularly true for non-ferrous materials, and particularly for non-metallic materials, such as high density plastics, and non-ferrous metals, including copper wiring. For example, one approach to recycling plastics has been to station a number of laborers along a sorting line, each of whom manually sorts through shredded waste and manually selects the desired recyclables from the sorting line. This approach is not sustainable in most economics since the labor component is too high.

While some aspects of ferrous and non-ferrous recycling has been automated for some time, mainly through the use of magnets, eddy current separators, induction sensors and density separators, these techniques are ineffective for sorting some non-ferrous metals, such as copper wire. Again, labor-intensive manual processing has been employed to recover wiring and other non-ferrous metal materials. Because of the cost of labor, many of these manual processes are conducted in other countries and transporting the materials adds to the cost.

A variety of plastics may be contained within a waste stream. Some such plastics include polypropylene (PP); polyethylene (PE); acrylonitrile butadiene styrene (ABS); polystyrene (PS), including high impact polystyrene (HIPS), and polyvinyl chloride (PVC). These materials are more valuable if separated, at least into “light” plastics (PP and PE) and “heavy” plastics (ABS and PS). Also, some plastics are undesirable, such as PVC and some PP, such as talc-filled and glass-filled PP. To increase the value of the segregated plastics, the undesirable plastics should be removed.

Many processes for identifying and separating materials are know in the art. However, not all processes are efficient for recovering plastics and non-ferrous metals and the sequencing of these processes is one factor in developing a cost-effective recovery process.

In view of the foregoing, a need exists for cost-effective, efficient methods and systems for recovering materials from a waste stream, such as materials seen in a recycling process, including plastics and non-ferrous metals, in a manner that facilitates revenue recovery while also reducing landfill.

### SUMMARY OF THE INVENTION

Exemplary embodiments of the present invention provide systems and methods for recovering materials such as plastics and non-ferrous metals. In one aspect of the invention, a method for recovering copper from a waste material is provided. The method includes the steps of: (a) removing ferrous metals from the waste material; (b) reducing the size of the waste material; (c) introducing the size-reduced waste material onto a water separation table; and (d) collecting copper from the water separation table.

Another aspect of the invention provides a system for recovering copper from a waste material. This system includes a ferrous metal subsystem, operable to remove ferrous metals from the waste material; a size reducer, operable to receive waste material from the ferrous metal subsystem and further operable to reduce the size of the waste material; and a water separation table, operable to receive the size-reduced waste material from the size reducer and further operable to separate copper from the received material.

Yet another aspect of the invention provides a method for recovering plastic from a waste material. This method includes the steps of: (a) reducing the size of the constituents of the waste material; (b) processing the ground waste material on a gravity table; (c) recovering a heavy fraction from the gravity table; (d) processing the recovered material using a hydrocyclone; (e) recovering the light fraction from the hydrocyclone comprising a plastic material; and (f) extruding the plastic material.

Yet another aspect of the invention provides a system for recovering plastic from a waste material. This system includes a size reducer; a gravity table, operable to receive size-reduced waste material and concentrate a plastic fraction in the ground waste material; a hydrocyclone, operable to further concentrate the plastic fraction in the size-reduced waste material; and an extruder, operable to receive a plastic fraction of the material and extrude plastic.

Yet another aspect of the invention provides a method for recovering materials from a waste stream. This method includes the steps of: (a) separating the waste stream into a heavy fraction and a plastics fraction using a density separator, wherein the heavy fraction comprises copper and the plastics fraction comprises a light plastic fraction and a heavy plastic fraction; (b) separating the light plastic fraction from the heavy plastic fraction; (c) pelletizing the heavy plastic fraction; and (d) concentrating the amount of copper in the heavy fraction using a water separation table.

### BRIEF DESCRIPTION OF THE DRAWINGS

FIG. 1 depicts an overall process flow diagram for recovering plastics and non-ferrous metals in accordance with an exemplary embodiment of the present invention.

FIG. 2 depicts a process flow diagram for separating materials by density in accordance with an exemplary embodiment of the present invention.

FIG. 3 depicts a process flow diagram for segregating desirable plastics from other materials in accordance with an exemplary embodiment of the present invention.

FIG. 4 depicts a process flow diagram for separating heavy plastics from light plastics in accordance with an exemplary embodiment of the present invention.

FIG. 5 depicts a process flow diagram for further processing the separated plastic for resell in accordance with an exemplary embodiment of the present invention.

FIG. 6 depicts a process flow diagram for separating higher density material into light and heavy fractions in accordance with an exemplary embodiment of the present invention.

FIG. 7 depicts a process flow diagram for separating materials by density in accordance with an exemplary embodiment of the present invention.

FIG. 8 depicts a process flow diagram for recovering metals in accordance with an exemplary embodiment of the present invention.

FIG. 9 depicts a process flow diagram for removing metal material in accordance with an exemplary embodiment of the present invention.

FIG. 10 depicts a process flow diagram for recovering copper in accordance with an exemplary embodiment of the present invention.

FIG. 11 depicts a system diagram for separating raw residue in accordance with an exemplary embodiment of the present invention.

FIG. 12 depicts a system diagram for a plastics recovery line in accordance with an exemplary embodiment of the present invention.

FIG. 13 depicts a system diagram for a wire recovery line in accordance with an exemplary embodiment of the present invention.

FIG. 14 depicts a process flow diagram for employing sink/float tanks to separate materials in accordance with an exemplary embodiment of the present invention.

FIG. 15 depicts a process flow diagram for processing recovered plastic materials in accordance with an exemplary embodiment of the present invention.

FIG. 16 depicts a process flow diagram for further processing recovered metal in accordance with an exemplary embodiment of the present invention.

### DETAILED DESCRIPTION OF THE EXEMPLARY EMBODIMENTS

Exemplary embodiments of the present invention provide systems and methods for recovering materials such as plastics and non-ferrous metals. Aspects of the invention employ density separation to separate plastic-bearing materials from copper-bearing materials. Plastic-bearing materials are further separated to separate light plastics from heavy plastics. Plastics are concentrated, extruded, and palletized. Copper and other valuable metals are recovered from copper-bearing materials using a water separation table.

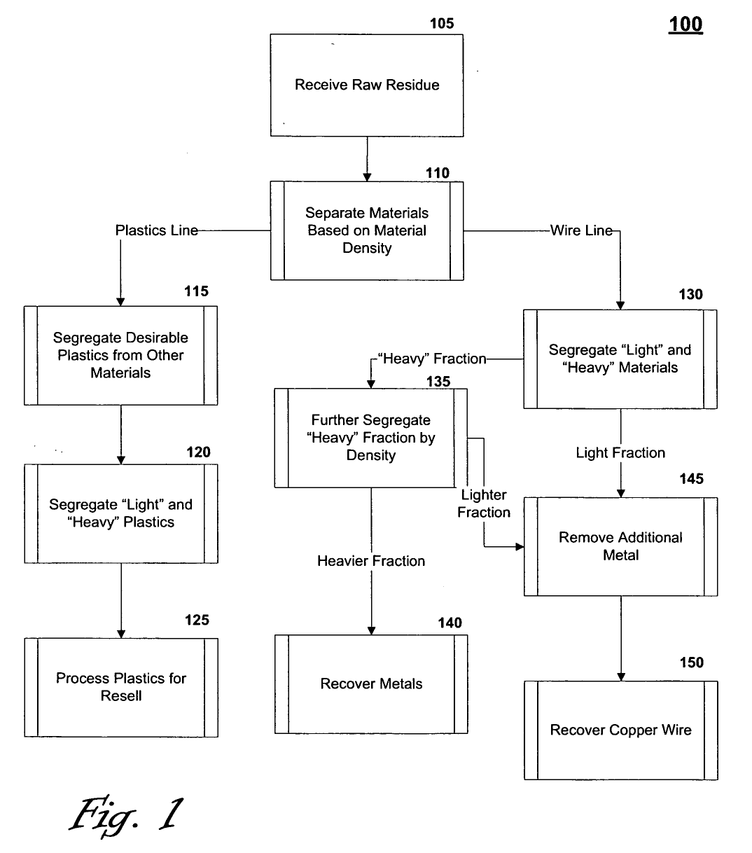

FIG. 1 depicts an overall process flow 100 for recovering plastics and non-ferrous metals in accordance with an exemplary embodiment of the present invention. Referring to FIG. 1, the process 100 begins at step 105 by receiving raw residue. This residue may result from prior processing of waste material, such as ASR and WSR. Typically, this raw residue is a waste product from this primary recycle and recovery effort. The exemplary process 100 provides a process to further recover materials and reduce the amount of ultimate waste material. The percentage of material recovered will vary based on the source of the raw residue. Raw residue from processing automobiles and other heavy appliances may have 30-35 percent of recoverable material.

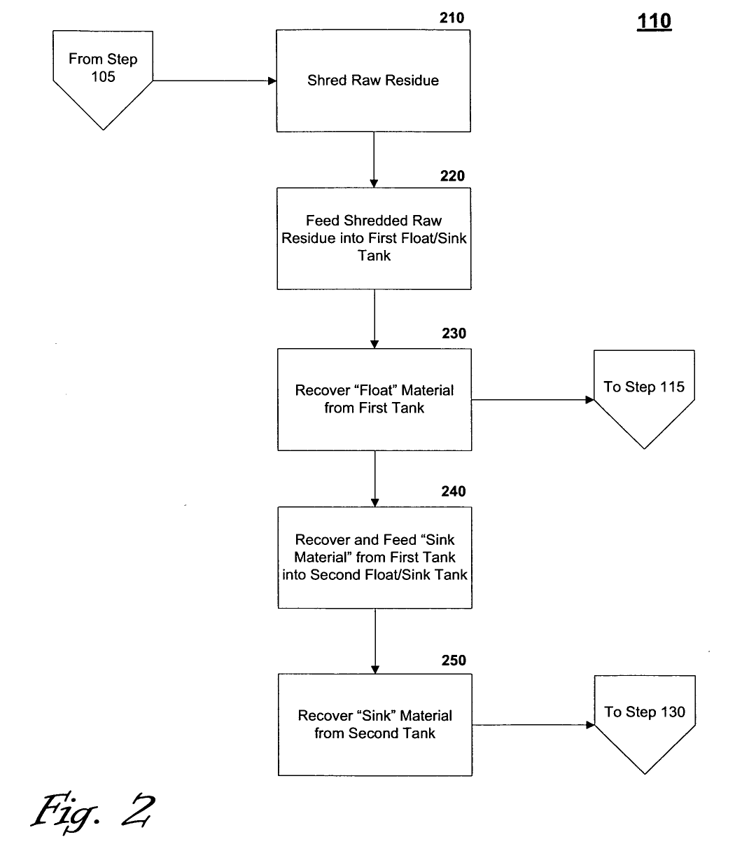

At step 110, the materials that constitute the raw residue are separated using a process that separates the materials based on each constituent's density. This process is described in greater detail below, in conjunction with FIG. 2.

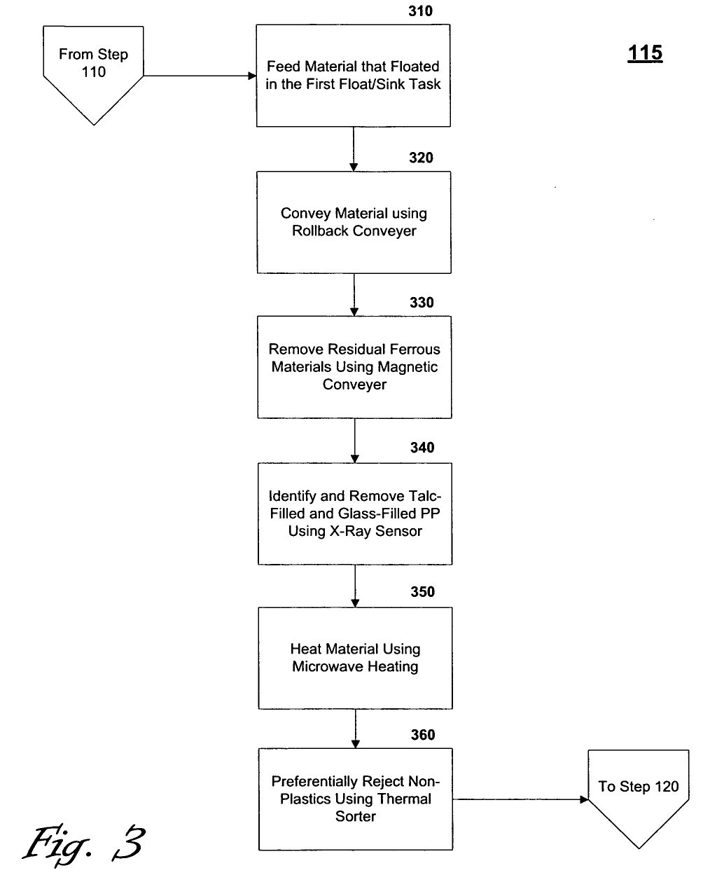

The processing at step 110 results in at least two material streams that are further processed. These two streams are referred to as the “plastic line” and the “wire line” herein. As the name suggests, the plastic line is used to recover valuable plastics from the raw residue. Similarly, the wire line is used to recover copper wiring or other valuable residual metals from the raw residue. At step 115, the plastic line begins. At this step, the process 100 segregates desirable plastics from other materials. This process is described in greater detail below, in conjunction with FIG. 3.

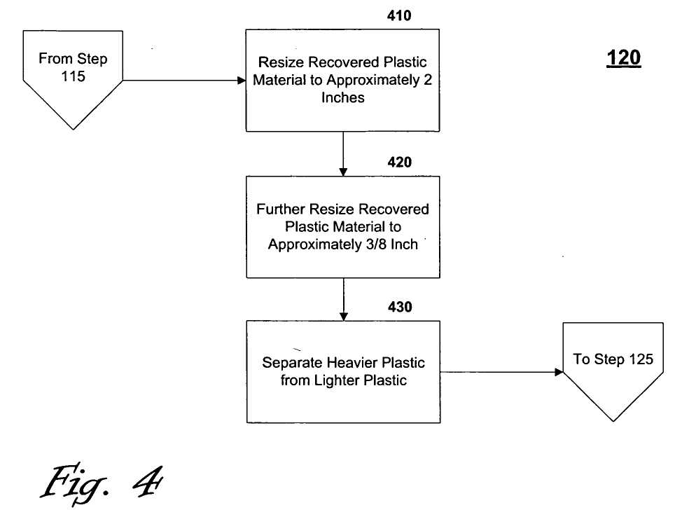

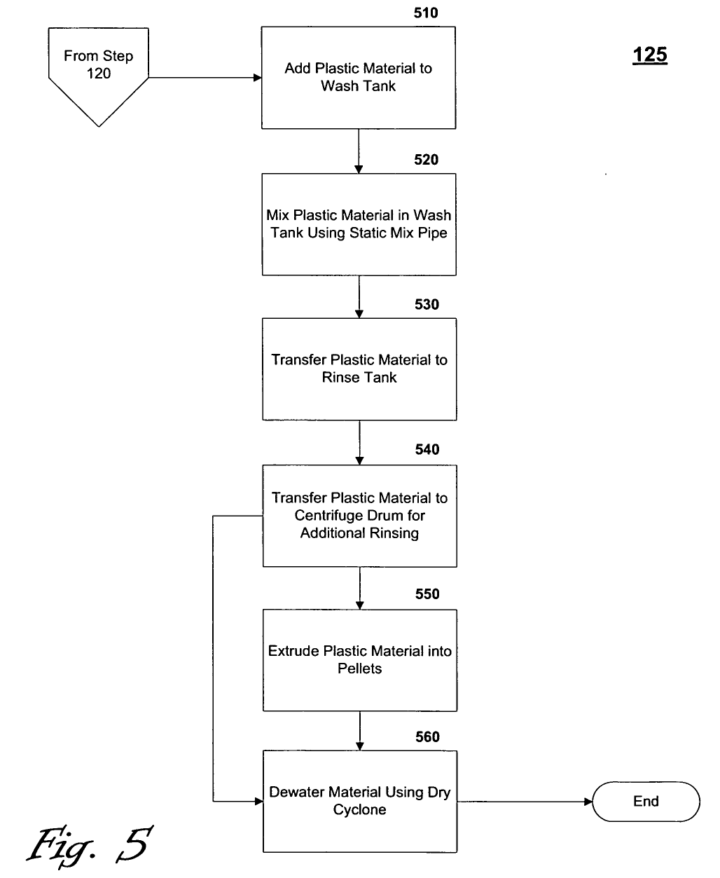

At step 120, the desirable plastic materials are further segregated into “light” plastics and “heavy” plastics. This process is described in greater detail below, in conjunction with FIG. 4. The terms “light” and “heavy” are used throughout this description to describe process products and feeds. These terms are relative terms—light materials are lighter than heavy materials and vice versa. These terms are not used to indicate the absolute weight of any of the materials. A “light” component from one waste process may be heavier than the “heavy” component of another process. At step 125, the segregated light and heavy plastics are processed for resell. This process is described in greater detail below, in conjunction with FIG. 5.

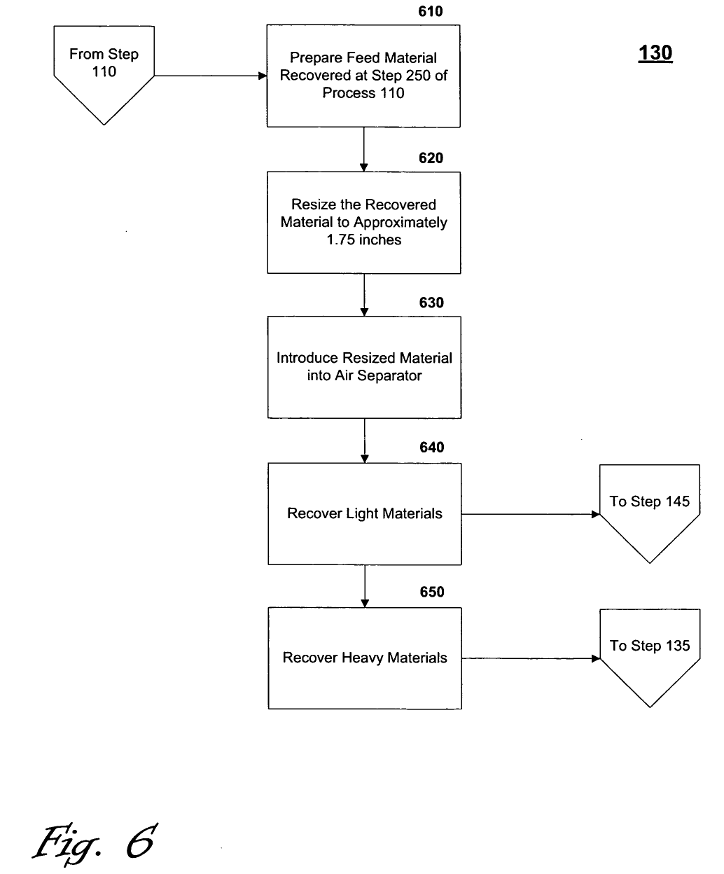

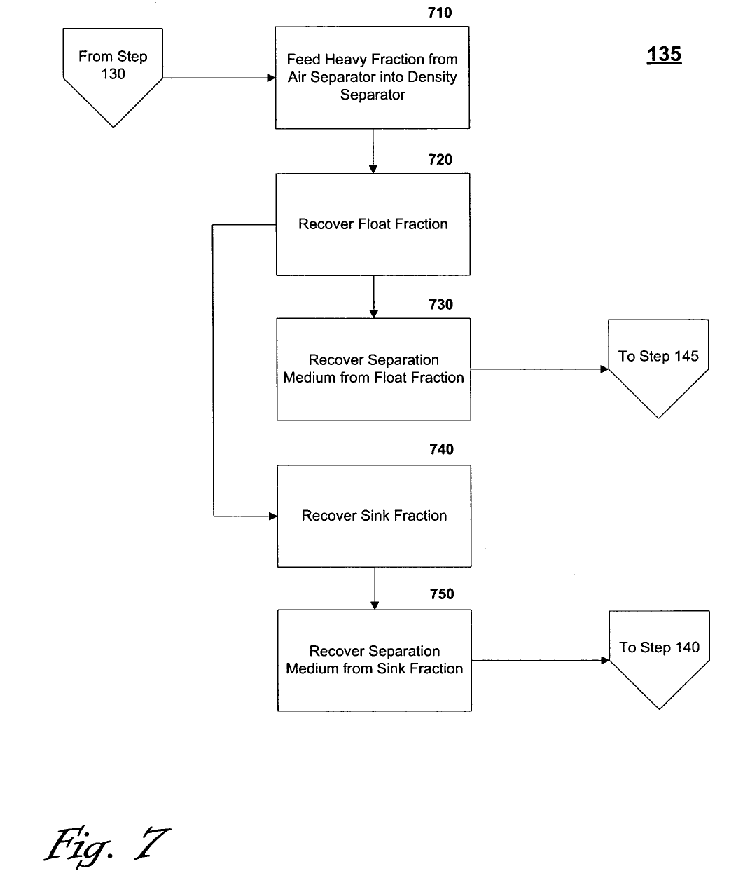

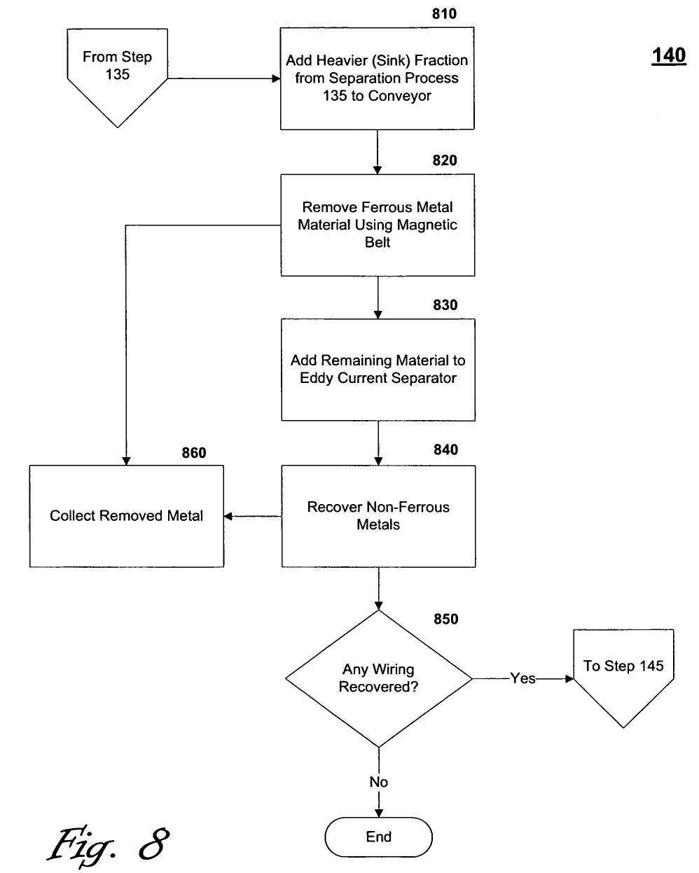

The wire line begins at step 130, where feed materials are segregated into light and heavy fractions. This process is described in greater detail below, in conjunction with FIG. 6. At step 135, the heavy fraction from step 130 is further processed, using a density separation process. This process is described in greater detail below, in conjunction with FIG. 7. At step 140, one of the resulting streams (the heavier fraction) is further processed to recover any valuable metal. This process is described in greater detail below, in conjunction with FIG. 8.

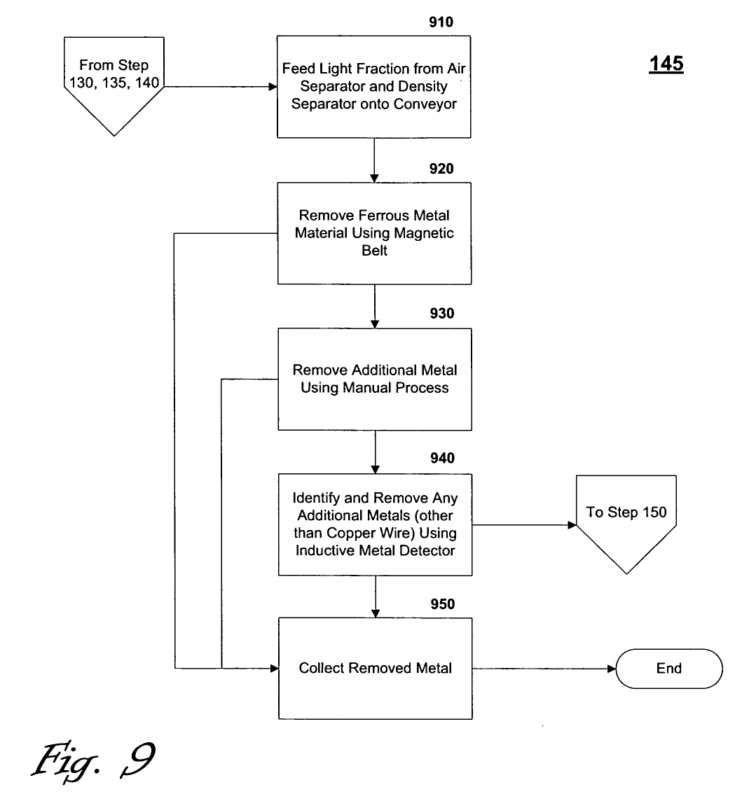

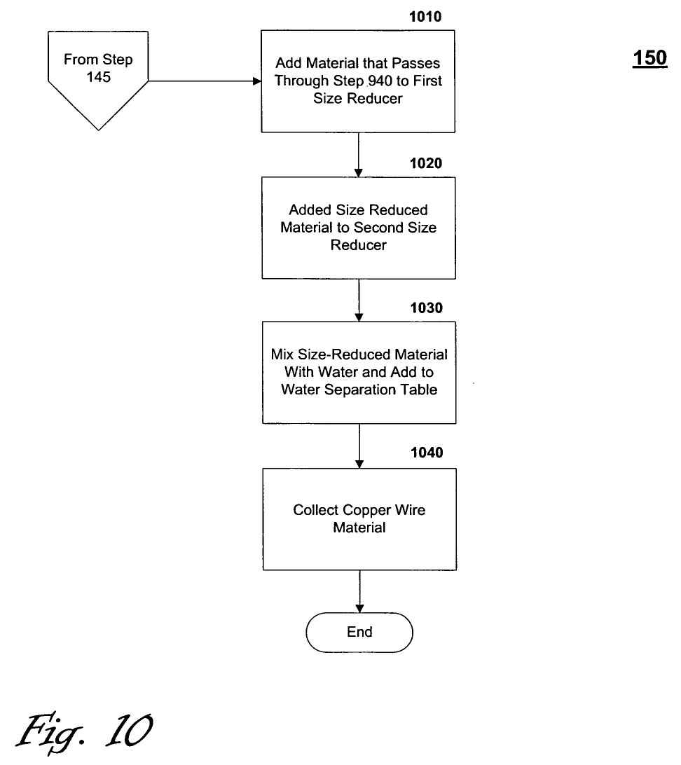

Step 145 processes the light fraction from step 130 and the lighter product from step 135. Copper wire identified at step 140 may also be added as feed at step 145. The process at step 145 is described in greater detail below, in conjunction with FIG. 9. Finally, at step 150, copper is recovered from the feed material. This process is described in greater detail below, in conjunction with FIG. 10.

Process 100 provides an integrated process for recovering light and heavy plastics and copper and other valuable metal from raw residue.

FIG. 2 depicts a process flow 110 for separating materials by density in accordance with an exemplary embodiment of the present invention. Referring to FIG. 2, process 110 begins at step 210, where the raw residue is shredded. The resulting material may be, on average, 1-2 inches in size. The shredding process may improve the separation achieved by process 110. In other exemplary embodiments of process 110, this step may be omitted.

At step 220, the shredded raw residue is added to a first float/sink tank to separate the raw residue based on the density of the constituents of the residue. Float/sink tanks are know in the art. These tanks include liquid or another medium that has a specific density. Materials that have a higher density than the medium tend to sink to the bottom of the tank while materials with a lower density than the medium tend to float on the surface of the medium. A common medium is water, which has a density of 1.0 grams per cubic centimeter (g/cc). Chemicals, such as salt, magnesium sulphite, calcium nitrate, and calcium chloride, may be added to the water to increase the medium's density. Another common medium is sand. One specific type of sand or a combination of types of sand can be used to reach the desired density. For this exemplary process 110, a density of from 1.1 to 1.2 g/cc is desired.

Raw residue can be added to the first float/sink tank through a variety of mechanisms, including conveyor belts, slides, chutes, or screw conveyors, such as an auger. The tank may include a mechanism to agitate the tank. This mechanism pushes all of the material down into the medium. The material that has a density lower than the medium's density then returns to the surface while the material with a density greater than that of the medium sinks to the bottom. The tank would also include mechanisms to recover the material. For example, a paddle system may move the floating material to one end of the tank for recovery while another extraction mechanism pulls or drivers the material at the bottom of the tank to the other end of the tank. Other recovery mechanisms may include screws, skimmers, or pumps.

Following step 220, the collected material is then removed from the tank. At step 230, the “float” material is recovered. This material will include light and heavy plastics. PP and PE typically have densities less than 1.0 g/cc. ABS and HIPS typically have densities of approximately 1.05 g/cc. Some of these material may have densities in the 1.1 to 1.2 g/cc range. This recovery step would included a screen or shaker, that removes the medium from the plastic. This removal allows for the recovery and reuse of the medium, which typically includes valuable chemicals or sand. If the medium is merely water, this recovery step would likely be omitted. The medium recovery process may include two or more. In the first stage, the medium is removed from the recovered material with the screen or shaker. The recovered material is then rinsed with water and put through another screen or shaker to collect the medium.

At step 240, the denser material from the first float/sink tank, that is, the material that sunk in the medium, is collected and added to a second float/sink tank. Although this exemplary embodiment includes two separate tanks, the first tank could be reused, although this approach could be less efficient. Again, prior to adding the denser material to the second tank, the material would be shaken to recover the medium from the first tank, so that the medium could be reused.

At step 240, the process as described in step 220 is repeated. In this step, however, the density of the medium is set to approximately 1.4-1.5 g/cc. At this density, materials that include copper and other recoverable metals will sink to the bottom of the tank. At step 250, these more dense materials, that is, the material that sinks, are recovered. This recovered material would include copper wire. Again, the material would be processed, such as with one or more stages of screens or shakers, to recover the tank medium and recover the valuable chemicals.

The material that floats in the second tank is typically without value and would be discarded, after it is processed through a screen or shaker to recover any entrained medium. For example, this material would include PVC, which has a density of approximately 1.3 g/cc. As such, the PVC would have sunk in the first tank and floated in the second tank. For some waste streams, this float material could be of value.

Following step 250, the material that sank in the second sink/float tank may be further treated to remove additional material that does not have value. For example, the material may be placed on a conveyor belt and passed through a color sorting machine. The color sorting machine includes one or more high resolution color cameras. These cameras are linked to a computer that processes the images from the camera. Material that is “black” (that is, very dark) or that is very large in size relative to the other material would represent material of little or no value. These materials would be removed from the recovered material stream, such as by using an air diverter system at the end of the conveyor belt, which would divert the unwanted materials from the stream so that these diverted materials would not be further processed. In another example, a friction belt may be employed to remove rocks and large pieces of metal.

Alternatively, the sink/float separation process may be replaced by a dynamic sensor system to identify metals, such as copper and other non-ferrous metals. A dynamic sensor is a modified inductive sensor. This modified sensor measures the rate of change of the amount of current produced in an inductive loop and detects the presence of metallic objects based on this rate of change. This process differs from how a standard inductive sensor detects metallic objects.

FIG. 3 depicts a process flow 115 for segregating desirable plastics from other materials in accordance with an exemplary embodiment of the present invention. Referring to FIGS. 2 and 3, process 115 is the beginning of an exemplary plastic line. At step 310, the material recovered at step 230 becomes the feed material for process 115. This material is the material that floated in the first float/sink tank of process 110.

At step 320, the feed material is added to a rollback conveyor, which includes an upwardly-inclined conveyor. This conveyor allows rounded material, such as foam, to be removed from the process stream. As the material move on the conveyor, the round foam and similar material rolls back down the conveyor, as it does not create enough friction to remain on the conveyor as it travels. The material that is removed at this step is typically waste.

At step 330, the material is transferred to a magnetic belt. Here, any ferrous debris is removed. For example, carpet “fluff,” which is carpet fragments from an automobile that has ferrous metal threads, would be removed at this point. Again, this ferrous debris would typically be waste.

At step 340, talc-filled PP and glass filled PP is identified using an x-ray sensor. The density differences in the talc-filled PP and glass filled PP cause these materials to produce a unique x-ray signature that can be used to detect the presence of these materials. Similarly, PVC has a unique x-ray signature. Although PVC would likely sink in a sink/float tank with a density of 1.1-1.2 g/cc, some PVC materials may get tied up with other lighter materials and float in the sink/float tank of process 110. PVC, along with the talc-filled PP and glass-filed PP can be identified and removed as waste. Step 340 can be taken at other points in the plastic line process. However, the x-ray process is most effective if done prior to reducing the plastic material to very small sizes.

At step 350, the remaining materials are heated using a microwave source. The material is passed by the microwave source on a conveyor belt. Microwaves are electromagnetic waves that have a frequency of about 2450 MHz and a wavelength of about 12.24 cm. Some materials absorb microwave beam energy in a process called dielectric heating. Many molecules are electric dipoles, meaning that they have a positive charge at one end and a negative charge at the other. When exposed to microwaves these dipoles rotate as they try to align themselves with the alternating electric field induced by the microwave beam. This molecular movement creates heat as the rotating molecules hit other molecules and put them into motion. Materials that tend to heat when exposed to microwaves include wood, rubber and foam. In contrast, other materials such as plastics are not heated when exposed to microwave radiation.

When exposed to the microwave radiation, wood, rubber, and foam pieces that may be on the conveyor belt absorb the microwave radiation and are heated through dielectric heating. The plastic pieces on the conveyor belt are not heated by the microwaves. The exposure time and microwave energy are both adjustable. The exposure time can be controlled by the speed of the conveyor belt and the area of the conveyor belt that is exposed to microwave radiation. The magnitude of microwave energy that is applied to the mixed pieces will also change the dielectric heating rate of the materials. Because microwaves can be very harmful to living creatures, the area of microwave exposure may be contained within a protective housing.

At step 360, a thermal sorter is used to sort the waste material (wood, rubber, and foam) from the desired plastic. The waste material will be higher in temperature than the plastic. For example, thermal imaging, such as by using a thermal camera, or other know temperature sensors can be used to identify the varying temperatures of the material. Air jets can be used to selectively remove unwanted debris (the wood, rubber, and foam) from the process stream. The air jets, which would be situated across the conveyor belt, would be controlled by a microprocessor that is connected to the thermal detection sensor. One of ordinary skill in the art would appreciate that other know diverting mechanisms could be used instead of air jets. Also, a dielectric sensor, which detects moisture content of materials, may be used to remove these undesirable materials.

FIG. 4 depicts a process flow 120 for separating heavy plastics from light plastics in accordance with an exemplary embodiment of the present invention. Referring to FIGS. 2, 3 and 4, at steps 410 and 420, the material that passed through the thermal detectors at step 360 are resized. At step 410, the material is resized to approximately 2 inches. If process 110 included the step of resizing the raw residue to approximately 2 inches, step 410 can be omitted. At step 420, the material is resized to approximately ⅜^{th} of an inch. The size reduction at steps 410 and 420 can be performed by a granulator or any know size reduction technique.

At step 430, the heavy and light plastics are separated. In one embodiment, the light and heavy plastics are combined with water to form a slurry. Then, a hydrocyclone is used to separate the light (PP and PE) and heavy (ABS and HIPS) plastics. A hydrocyclone is a closed vessel designed to convert incoming liquid velocity into rotary motion. The hydrocyclone does this conversion by directing inflow tangentially near the top of a vertical cylinder. As a result, the entire contents of the cylinder spins in the chamber, creating centrifugal force in the liquid. Heavy components move outward toward the wall of the cylinder where they agglomerate and spiral down the wall to an outlet at the bottom of the vessel. Light components move toward the axis of the spinning liquid, where they move up toward an outlet at the top of the vessel.

As a result of using a hydrocyclone at step 430, the light plastics would exit the top of the hydrocyclone and the heavy plastics would exit the bottom of the hydrocyclone. The heavy plastics may need to be run through the hydrocyclone a second time to remove any heavy debris. In this second run, the desirable plastics would come out the top of the hydrocyclone and unwanted debris would exit at the bottom of the hydrocyclone.

In an alternative embodiment, air separation can be used. For example, a “Z-box” could be used. The Z-box is so named because of its shape. Dry material is added at the top of the Z-box and falls by gravity. Air is forced up through the falling material. Lighter material (PP and PE) would be entrained in the air while heavy material (ABS and HIPS) would fall out. The “Z” shape forces the falling material to impact walls of the chamber, thus releasing lighter materials that may be combined with heavier materials.

FIG. 5 depicts a process flow 125 for further processing the separated plastic for resell in accordance with an exemplary embodiment of the present invention. In order to resell the recovered plastic it should be cleaned and, perhaps, transformed into a different form. Referring to FIG. 5, plastic material, either the light plastic or heavy plastic, is added to a wash tank at step 510. The wash tank includes water and a detergent. The plastic, water, and detergent are agitated. Many ways to agitate a tank are known. In this exemplary embodiment, at step 520, the plastic is agitated by pumping the tank contents through a static mix pipe and recirculating the material to the tank. The static mix pipe is a pipe that includes fixed baffles or other protrusions that force plastic/water/detergent mixture to take a tortuous path through the pipe. This movement causes the agitation that allows the plastic to be cleaned. Alternatively, an in-tank agitator could be used, such as a propeller. In another alternative embodiment, both a propeller or static mixer could be used or another type of agitation could be employed.

At step 530, the plastic is transferred to a rinse tank. This tank operates similarly to the wash tank, although no detergent is included. At step 540, the plastic is transferred to a second rinse tank. In this tank, the plastic is spun in a centrifugal drum as rinse water is sprayed on the plastic. Alternatively, other known rinsing processes could be used at steps 530 and 540.

The heavy plastics should be pelletized prior to resell. The light plastics may or may not be pelletized. At step 550, the heavy plastic is extruded and cut into pellets. That is, the plastic is heated and pushed through a suitable extrusion die. A knife then cuts pellets of a desired size. The light plastics may also be extruded into pellets or step 550 may be skipped for the light plastics. At step 560, the plastic material is dewater. This process may include a dry cyclone, although other processes could be used.

The details of the “plastic line” presented above, in particular as associated with FIG. 4, included separating the heavy and light plastics after microwave processing to remove debris and before cleaning. Alternatively, the feed for the plastic line (the “float” material from the first tank of process 110, FIG. 2) could be sent through a process to refine and separate the materials. This alternative process includes the use of dialectic sensors to distinguish plastics from other materials. The process also includes a sink/float tank with a density of 1.0 g/cc, achieved using water, sand, or other medium. In this process, the light plastics should float and the heavy plastics sink.

FIG. 6 depicts a process flow 130 for separating higher density material into light and heavy fractions in accordance with an exemplary embodiment of the present invention. This process 130 begins the wire line. Referring to FIGS. 2 and 6, at step 610, feed material recovered at step 250 of process 110, that is, the “sink” material from the second float/sink tank of process 110, is prepared. This preparation may include adding the material to a shaker feeder or other conveyance system. At step 620, the material is added to a size reducer, such as a granulator or other known size reducer, including a ring mill. The material is resized to approximately 1.75 inches. This step may be omitted if the raw residue is shredded to 2 inches in process 110 at step 210.

At step 630, the material is added to an air separator, such as a Z-box. The general operation of a Z-box is described above, in connection with FIG. 4. As a result of this operation, a light fraction and a heavy fraction will be produced. Both fractions will likely contain wire pieces, which are ultimately to be recovered by the wire line. Both fractions may also contain other metals, although the heavy fraction would likely contain most of these other metals. At steps 640 and 650, the light and heavy fractions are recovered.

Other types of air separators could be used at step 630. For example, materials are introduced into gravity-fed air aspirator system, typically from the top, and they drop by gravity through the system. Air is forced upward through the air separation system. Lighter materials are entrained in the air and are removed out of one part of the system. Typically, these separators do not have the characteristic shape of a “Z-box,” but may have other features, such as baffles, to enhance the separation of materials. These air separation systems may include multiple stages, or cascades, where material that falls through one stage is introduced into a second stage, and so on.

FIG. 7 depicts a process flow 135 for separating materials by density in accordance with an exemplary embodiment of the present invention. Referring to FIGS. 6 and 7, at step 710, the heavy material recovered at step 650 is added to a density separator. This separator may be a sand flow tank. As with a liquid-filled float/sink tank, the sand acts as a float medium. Depending on the desired density, a wide variety of sands or sand-like media could be used. Materials with a density greater than the sand sink while material with a density less than the sand float. At step 720, the “float” fraction is recovered. At step 730, the recovered material goes through a shaker to recover any of the sand medium. At step 740, the “sink” fraction is recovered. Again, at step 750, the recovered material goes through a shaker to recover any of the sand medium.

FIG. 8 depicts a process flow 140 for recovering metals in accordance with an exemplary embodiment of the present invention. Referring to FIGS. 7 and 8, at step 810, the heavier (sink) fraction from process 135, recovered at step 740, is added to a conveyor. At step 820, ferrous materials are removed using a magnetic belt. At step 830, the remaining material is added to an eddy current separator.

An eddy current separator includes a rotor comprised of magnet blocks, either standard ferrite ceramic or the more powerful rare earth magnets, are spun at high revolutions (over 3000 rpm) to produce an “eddy current.” This eddy current reacts with different metals, according to their specific mass and resistivity, creating a repelling force on the charged particle. If a metal is light, yet conductive such as aluminum, it is easily levitated and ejected from the normal flow of the product stream making separation possible. Separation of stainless steel is also possible depending on the grade of material. Particles from material flows can be sorted down to a minimum size of 3/32″ (2 mm) in diameter. At step 840, any non-ferrous metals separated using the eddy current separator are recovered. Additionally, one or more inductive sensors may be employed to further separate the material. In some cases, an inductive sensors with a sensing window set to identify stainless steel may be used. Removing stainless steel helps to reduce the wear on size reducing equipment used later to process this material.

Copper wire may move along this material stream and end up at the eddy current separator. At step 850, the process 140 determines if any copper wire is identified. If so, the copper wire is put back into the wire line process at step 145 (FIG. 1, above, and FIG. 9, below)). Also, the metal recovered during the process 140 may have value. This metal is collected at step 860. Alternatively, this separation process could be replaced by a fluidized bed drier. In this process, the “heavy fraction” from an air separator would be added to the fluidize bed. Stainless steel and other valuable metals would be recovered at the bottom of the bed.

FIG. 9 depicts a process flow 145 for removing metal material in accordance with an exemplary embodiment of the present invention. Referring to FIGS. 6, 7, 8, and 9, process 145 begins at step 910, where the light fraction from the air separator (the Z-box) recovered at step 640 of process 130 is combined with the “float” fraction recovered at step 720 of process 135 and any wire recovered at step 840 of process 140 and placed onto a conveyor. The conveyor includes a magnetic belt. At step 920, the magnetic belt removes any ferrous materials. For example, carpet “fluff,” which is carpet fragments from an automobile, would have metal threads that would allow the fluffs to be removed at this point. This ferrous debris would typically be waste. Alternatively, the “float” fraction recovered at step 720 of process 135 may be returned to step 620 of process 130 rather than be introduced at process 145. The purpose of looping back to process 130 would be to remove additional non-copper metal.

At step 930, the process 145 may include a manual process, were visible metal pieces are removed. Alternatively, this manual process could be omitted. At step 940, any additional metal, except for metal wire and, possibly aluminum, is removed using a metal detection system. The metal pieces are detected with inductive proximity detectors. The proximity detector comprises an oscillating circuit composed of a capacitance C in parallel with an inductance L that forms the detecting coil. An oscillating circuit is coupled through a resistance Rc to an oscillator generating an oscillating signal S1, the amplitude and frequency of which remain constant when a metal object is brought close to the detector. On the other hand, the inductance L is variable when a metal object is brought close to the detector, such that the oscillating circuit forced by the oscillator outputs a variable oscillating signal S2. It may also include an LC oscillating circuit insensitive to the approach of a metal object, or more generally a circuit with similar insensitivity and acting as a phase reference.

Oscillator is powered by a voltage V+ generated from a voltage source external to the detector and it excites the oscillating circuit with an oscillation with a frequency f significantly less than the critical frequency fc of the oscillating circuit. This critical frequency is defined as being the frequency at which the inductance of the oscillating circuit remains practically constant when a ferrous object is brought close to the detector. Since the oscillation of the oscillating circuit is forced by the oscillation of oscillator the result is that bringing a metal object close changes the phase of S2 with respect to S1. Since the frequency f is very much lower than the frequency fc, the inductance L increases with the approach of a ferrous object and reduces with the approach of a non-ferrous object.

A variety of inductive proximity detectors are available which have specific operating characteristics. In the exemplary process 145, the inductive proximity sensors are used to detect non-ferrous metals that may damage downstream machines, that is, metal pieces that are not fine or soft, such as copper and, possibly, aluminum.

At step 950, any detected metal is removed and, if valuable, collected. Air jets can be used to selectively remove the identified metal from the process stream. The air jets, which would be situated across the conveyor belt, would be controlled by a microprocessor that is connected to the metal detection sensor. Other know diverting mechanisms, could be used instead of air jets. For example, vacuum systems or mechanical arms featuring suction mechanisms, adhesion mechanisms, grasping mechanisms, or sweeping mechanisms could be employed.

FIG. 10 depicts a process flow 150 for recovering copper in accordance with an exemplary embodiment of the present invention. Referring to FIGS. 9 and 10, at step 1010, the material that passes through the metal detection process step 940 is added to a first size reducer. This step reduces the added material to approximately 1 inch in size. At step 1020, the material is added to a second size reducer to reduce the material to approximately ¼ inch. The granulators used in steps 1010 and 1020 of the exemplary process 150 may be damaged if metal, other than soft metal such as copper and, possibly aluminum, are introduced to the granulators.

At step 1030, the size reduced material is mixed with water. This mixture is then added to a water separation, or gravity concentration, table at step 1040. This table is pitched so that water flows towards one corner of the table. The table also has ridges, or riffles, that catch heavier solid material entrained in the water. Water and light solid material moves over the ridges and off the table. The heavier solid material is caught in the ridges and washed down the table, in the direction of the pitch of the table. Additional water is also introduced to promote the washing of the heavier solid material down the ridges.

Essentially, water separation tables are flowing film concentrators. Flowing film concentrators have a thin layer of water flowing across them, where these layers of water include entrained solid materials, materials with different densities. The film of water has varying velocities based on the distance from the water's surface. The highest velocity is the layer of water just below the surface of the water, and the lowest velocity layer, next to the deck surface of the table, is not moving at all. In between these layers the water moves at differing velocities, based upon the distance from the water's surface.

On a table, with particles of mixed densities, layers of material form, a particle in suspension will be subjected to a greater force the nearer it is to the surface of the water, and will cause it to tumble over those at greater distances from the surface. The combination of the particles tumbling and sliding and the flowing stream with differing velocities, will cause the bed of solids to dilate, and will allow high specific gravity particles to find their way down through the bed of low specific gravity particles, and eventually the low specific gravity particles will work their way to the top, where they will be carried along by the swifter flowing water.

A pattern of raised ridges (riffles) across the length of the table causes the higher density particles to stay behind the ridge, since they are closest to the bottom of the flowing water film. These particles, which would include the copper wire pieces, follow the ridge down the slope to the discharge, with the residence time giving the water flowing across the ridge more time to remove any low specific gravity particles (debris) trapped in the high specific gravity particle bed behind the ridge of the table.

Since the water is flowing perpendicular to the ridges or riffles of the table, the low specific gravity material will be washed over the top of the ridges and off the tailings discharge side of the table. The ridges of the table may be staggered to promote movement of the heavier solid material to the lowest corner of the table. In other words, the ridges extend a shorter length at the top, where the material and water mixture is introduced, as compared to the bottom. This arrangement results in a high concentration of copper at the lowest corner of the table. The copper is caught in the ridges and moves down the ridges by the force of the water, which pushes it to the lowest corner. At this point, copper is collected and is in a form to be sold, as the insulating wire was removed in the resizing process. At the corner opposite this low corner, relatively copper-free water comes off the table at the tailings discharge point. Along the edge between these two corners, the copper fraction increases. As some point, this middle portion of discharge, that contains some copper mixed with other debris, may be collected and, possibly reintroduced to the table to recover more of the copper. Also, in addition to copper, other metal, mixed with the copper, may be recovered in this process.

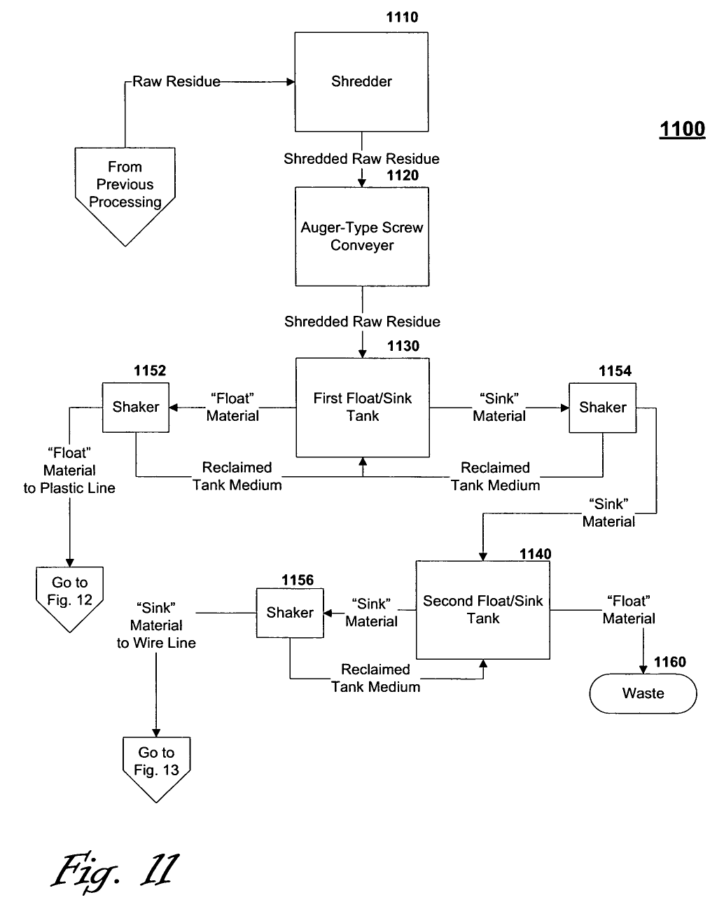

FIG. 11 depicts a system diagram 1100 for separating raw residue in accordance with an exemplary embodiment of the present invention. Referring to FIG. 11, at step 1110, raw residue, such as ASR or WSR, is further shredded to achieve a size of approximately 2 inches. At step 1120, the shredded residue is added to a screw auger or other conveyor. At step 1130, the material is introduced into a first sink/float tank or other density separator.

The light fraction from step 1130, such as “float” material from the first sink/float tank, is recovered and, at step 1152, medium from the density separation process is recovered, such as with a shaker, which shakes off any entrained liquid or other separation medium from the recovered material. The “float” material is then further processed in the plastic line to recover plastics.

The heavy fraction from step 1130, such as “sink” material from the first sink/float tank, is recovered and, at step 1154, medium from the density separation process is recovered, such as with a shaker, which shakes off any entrained liquid or other separation medium from the recovered material. The “sink” material is then introduced into a second density separator, such as a second sink/float tank, at step 1140.

The heavy fraction from step 1140, such as “sink” material from the second sink/float tank, is recovered and, at step 1156, medium from the density separation process is recovered, such as with a shaker, which shakes off any entrained liquid or other separation medium from the recovered material. The “sink” material is then further processed in the wire line to recover copper and other valuable metals. The “float” material is discarded as waste at step 1160.

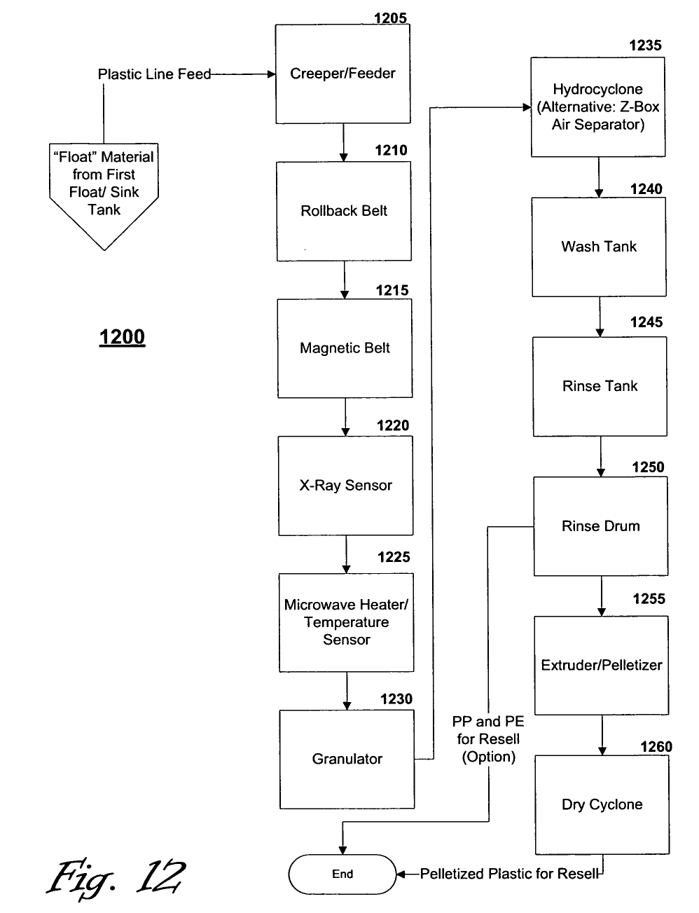

FIG. 12 depicts a system diagram 1200 for a plastics recovery line in accordance with an exemplary embodiment of the present invention. Referring to FIGS. 11 and 12, at step 1205, material to be further processed in the plastic line, such as the light fraction recovered at step 1130, is introduced onto a creeper/feeder. At step 1210, the material is put on a rollback belt, to remove light, generally rounded material, such as foam. This material is discarded as waste. At step 1215, the material moves from the rollback belt to a magnetic belt to remove ferrous material, including carpet with embedded metallic fibers or fines.

At step 1220, the material is introduced into an x-ray system, which identifies talc-filled PP, glass filled PP, and PVC. These materials are typically undesirable and are removed from the waste stream. At step 1225, the remaining material is subjected to microwave heating and thermal sorting, to remove wood and rubber.

At step 1230, the material is introduced into a size reducer, such as a granulator. At step 1235, the size-reduced materials are processed with a hydrocyclone to separate light plastics from heavier plastics. Alternatively, a Z-box or other air separator may be used to separate the plastics.

At steps 1240, 1245, and 1250, the separated plastics are introduced into a wash tank, a rinse tank, and a rinse drum, respectfully, to clean the plastic. These materials would be processed in batches. One batch would include light plastics and another batch would include heavy plastics as separated at step 1235. Alternatively, other processes to wash and rinse the plastic may be employed.

At step 1255, the washed plastic material is introduced into an extruder and pelletizer. In one embodiment, only the heavy plastics would be processed at step 1255. At the same time that the recovered material is added to the extruder, modifiers are added to the material to knit the polymers during the extrusion process. At step 1260, the pelletized material is dried in a dry cyclone. Alternatively, the material may be dried prior to introducing the material into the extruder and step 1260 can be skipped.

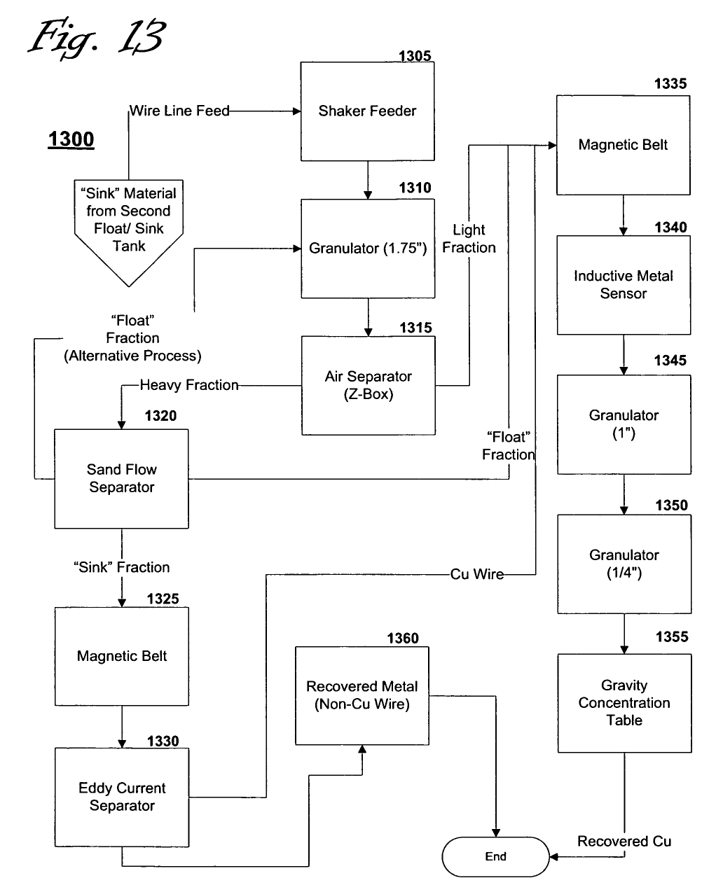

FIG. 13 depicts a system diagram 1300 for a wire recovery line in accordance with an exemplary embodiment of the present invention. Referring to FIGS. 11 and 13, at step 1305, material to be further processed in the wire line, such as the heavy fraction recovered at step 1140, is introduced onto a shaker feeder. At step 1310, the material is size reduced to approximately 1.75 inches in a granulator. At step 1315, the size-reduced material is introduced into an air separator, such as a Z-box.

At step 1320, the heavy fraction from the air separation step is introduced into a density separator, such as a sand flow separator. The heavy fraction from the sand flow separator, the “sink” fraction, is introduced onto a magnetic belt at step 1325 to remove ferrous materials and then processed with an eddy current separator at step 1330. At step 1360, metal, other than copper wire, recovered from the eddy current separator is collected.

The light fraction from the air separator (step 1315) along with the light fraction from the sand flow separator (step 1320) and any copper identified in the eddy current separator (step 1330) is added to a magnetic belt 1335 to separate ferrous materials. At step 1340, the material is further processed by an inductive sensor to remove additional metals, other than copper and possibly, aluminum.

At steps 1345 and 1350, the material is size reduced to one inch and one-quarter inch, respectively, such as by a granulator or other size reducing process. At step 1355, the material is added to a water separation table to separate copper from the size-reduced material.

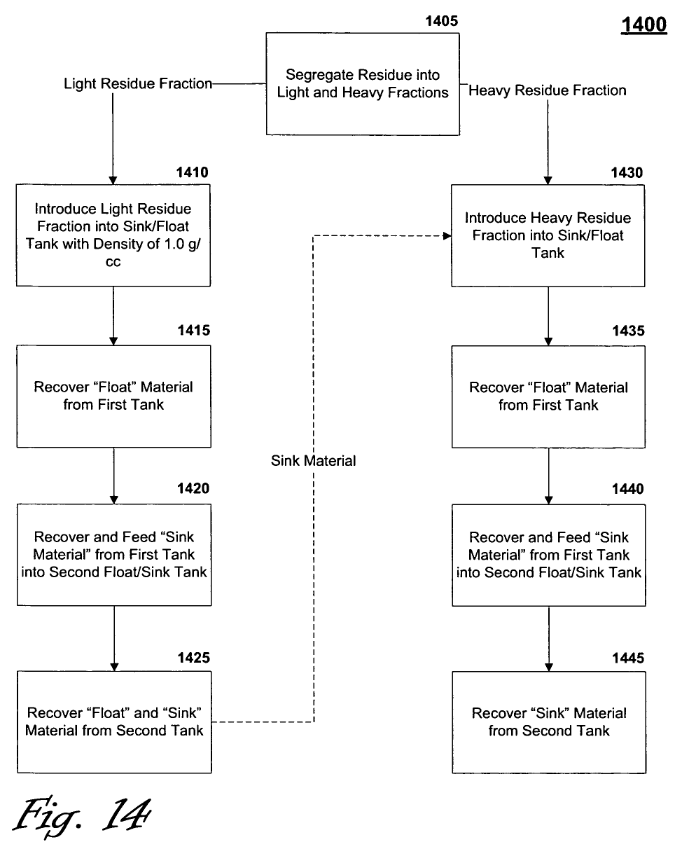

FIG. 14 depicts a process flow diagram 1400 for employing sink/float tanks to separate materials in accordance with an exemplary embodiment of the present invention. Referring to FIG. 14, in this exemplary embodiment, at step 1405, incoming shredder residue is segregated into a light fraction and a heavy fraction. This segregation may be accomplished using a Z-box or similar air sorting system, which can separate materials based in the material's weight. Other methods maybe employed. The material may be reduced in size to approximately 1-2 inches prior to the segregation.

After this initial segregation, the light residue fraction and heavy residue fraction are processed separately. At step 1410, the light residue fraction is introduced into a first sink/float tank. In this exemplary embodiment, the tank contains water, at a density of 1.0 g/cc. At step 1415, the material that floats in the first sink/float tank, that is, material with a density less than 1.0 g/cc, is recovered. This recovered material would include PP and PE.

In an alternative embodiment, prior to step 1410, the light residue fraction may pass through an air aspirator. In an air aspirator, material is fed from the top of the aspirator and falls through a chamber while air is introduced at the bottom of the chamber and flows upward. The air will entrain light components, which are then carried out the top of the chamber. This preprocessing action would remove light components, such as “fluff” and carpet. These light components represent materials that have no value if recovered. Prior to passing the light fraction through the aspirator, the materials may be placed on a rollback conveyor, to remove round objects. These round objects are likely foam material that represents unwanted material. Also, the aspirator may be a “waterfall” aspirator, which includes several individual chambers, or stages, within the aspirator. In each stage, the material is subjected to a counter airflow to remove lighter materials. As such, with each successive stage, the processed light residue fraction has less of these undesirable light components.

At step 1420, the material that sank in the first sink/float tank is recovered and introduced into a second sink/float tank. This second sink/float tank would have a density in the range of 1.1 to 1.2 g/cc. As previously discussed, this density may be achieved by using chemicals, such as salt, calcium carbonate, calcium nitrate, or other chemical suitable to adjust the density of water.

At step 1425, the float material is recovered from the second sink/float tank. This recovered material would include ABS and HIPS. As part of this recovery process, the material may be dewatered. This dewatering step allows for the recovery of chemicals used to adjust the density of the water. Screens or shakers may be used to shake the liquid from the material. This process may include multiple stages and the material may be rinsed with water between stages to rinse the chemical-bearing liquid from the material. The recovered liquid may pass through a clarifier and evaporator to recover the chemicals.

The material that sinks in the second sink/float tank may also be recovered. This material may include copper wire or other metals and may be combined with the heavy residue fraction generated at step 1405. The material may be dewatered to recover the chemical-bearing liquid medium. In other cases, the material may be relatively free of metal and, in that case, the material may be discarded.

The heavy residue fraction, and possibly material from step 1425 of the light residue fraction process, is introduced into another sink float tank, at step 1430. This sink float tank may have a density of 1.0 g/cc or greater, such as in the range of 1.0-1.2 g/cc. At step 1435, the material that floats in this sink/float tank is recovered. This material is discarded as waste. The material may be dewatered to recover the chemical-bearing liquid medium.

In an alternative embodiment, the heavy fraction may not be processed at step 1430, using the float tank. Instead, the float tank may be replaced with an air aspirator. This process may achieve the same goal as the sink/float tank—to separate light materials from the metals contained in the heavy residue fraction. Prior to introducing the material into an air aspirator, the heavy residue fraction may be placed on a rollback conveyor to remove round objects, which often represent non-valuable debris. Then, the heavier materials would be processed in the sink/float tank as described below, in connection with step 1440.

At step 1440, the material that sank in the sink/float tank of step 1430 is recovered and introduced into another sink/float tank. This tank would have a density greater than 1.2 g/cc and typically in the range of 1.4-1.5 g/cc. At step 1445, the material is recovered from this sink/float tank. The material that sank in this tank is processed to recover copper wire and other metals. The material that floated is discarded as waste. These materials may be dewatered to recover the chemical-bearing liquid medium.

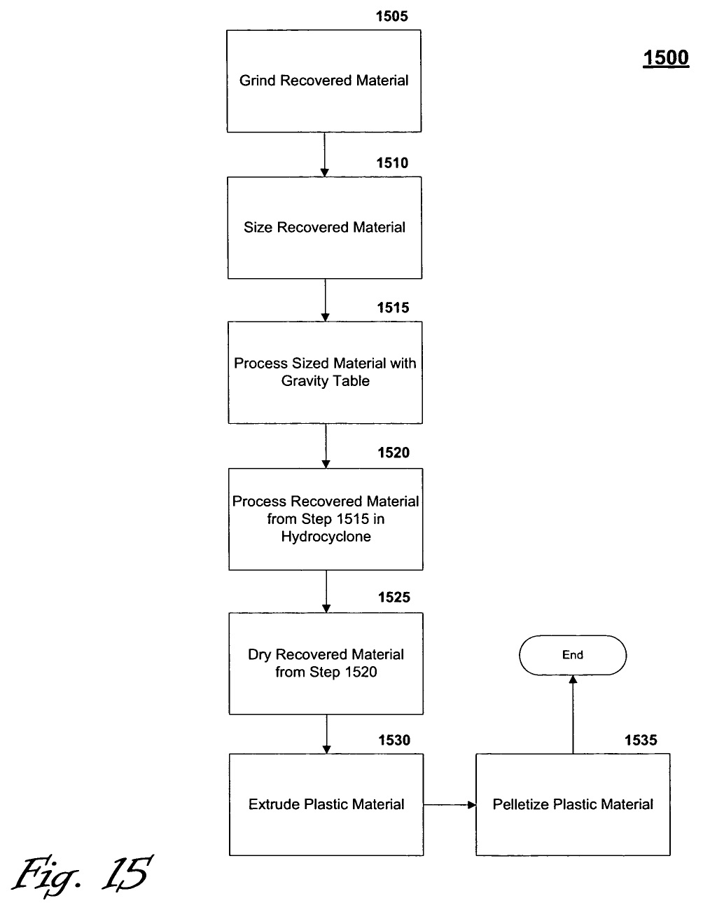

FIG. 15 depicts a process flow diagram 1500 for processing recovered plastic materials in accordance with an exemplary embodiment of the present invention. Referring to FIG. 15, at step 1505, the plastic feed material, such as PP and PE recovered at step 1415 of FIG. 14, is size-reduced, such as to a size of ⅜ inches, with a granulator. This size reduction provides some drying of the material, as the grinding generates heat. If necessary, the material is further dried in a fluidized bed dryer.

At step 1510, the material is sized. An air screen is used to separate materials that are too small to be processed (“fines”) or that are oversized. If the oversized material is predominantly plastic, it may be reintroduced into the size reducer at step 1505.

At step 1515, the sized material is introduced to a dry gravity table, perhaps through a screw auger. The gravity table is tilted and shakes to provide separation of the materials based on the materials' weight. Unlike the gravity table described in connection with FIG. 10, above, this gravity table does not mix the input material with water prior to separation. Heavier materials are collected from the top of the table for further processing. Light materials are discarded. Mid-range materials are re-introduced into the table for further separation. Steps 1505-1515 represent “dry” process steps.

At step 1520, the material collected at step 1515 for further processing is mixed with water and introduced into one or more hydrocyclones. The plastic material collected at step 1515 may be blended with previously recovered material to provide a consistent feed material for the hydrocyclone. In this exemplary embodiment, six hydrocyclones, in series, are used. Of course, a different number of hydrocyclones could be employed or a single hydrocyclone could be employed, with the material passed through the single hydrocyclone multiple times. The water may include detergent to wash the plastic as it passes through the hydrocyclones.

The lighter material is recovered from the hydrocyclone processing and is dried at step 1525. This step may include multiple substeps. For example, the material may first be spun dried, then rinsed, then spun dried again. The material may then be introduced into a vibratory heat drier. This step ends the “wet” process steps for process 1500.

At step 1530, the material is introduced into an extruder. The material may be blended with previously-recovered plastic material for a consistent feed into the extruder. At the same time that the recovered material is added to the extruder, modifiers are added to the material to knit the polymers during the extrusion process.

After extrusion, the material is pelletized, at step 1535. Alternatively, the extrusion and palletizing steps may be skipped and the material sold as recovered.

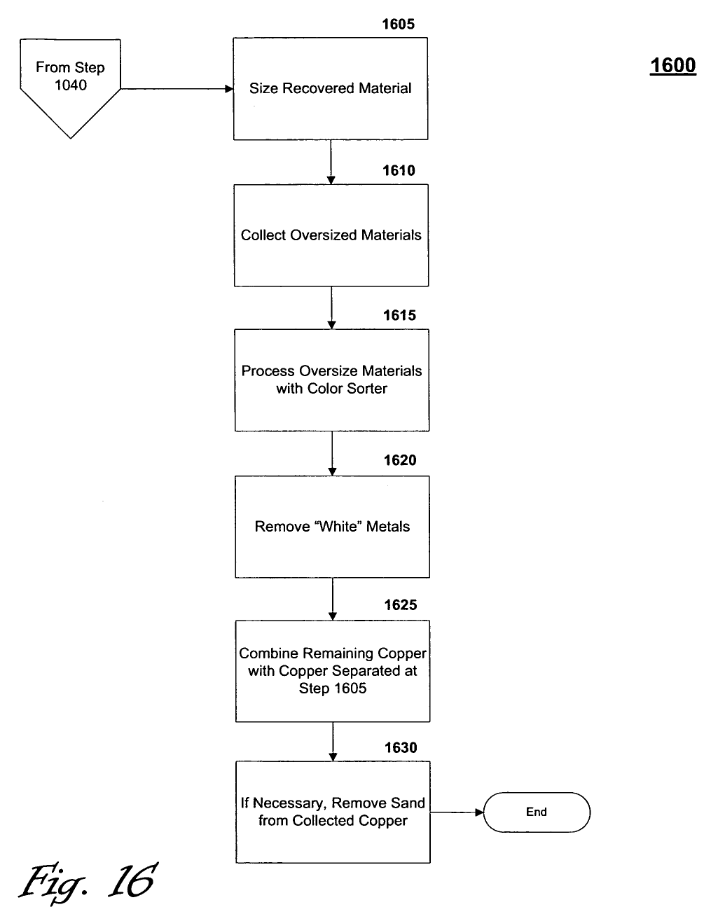

FIG. 16 depicts a process flow diagram 1600 for further processing recovered copper metal in accordance with an exemplary embodiment of the present invention. Referring to FIGS. 10 and 16, at step 1605, the copper and other metal collected at step 1040 is sized. Oversized material is collected at step 1610. This material would typically include most of the pieces of “white” metal (such as aluminum and zinc) in the recovered material, and some copper. A color sorter is then used to process this collected material at step 1615. The color sorting includes high resolution color cameras connected to a computer, which processes the images from the cameras to identify the “white” metal pieces. These pieces are removed, by a material diverting system such as an air knife, at step 1620.

At step 1625, the remaining copper from the collected oversized material is combined with the copper that passed through the sizing process at step 1605. At step 1630, this material is further processed, if necessary, to remove any sand that may be mixed with the copper. In this further processing step, the material is introduced into a mechanical screen system. The screen system separates the material into three streams, based on material size. One steam contains the copper. The second stream contains copper mixed with sand. The third stream is predominantly sand. The mixed copper/sand stream may be further processed using a roll crusher to crush the sand into powder and a destoner, that employs a screen that holds the material with air passing up through the screen to entrain the sand powder and carry it away from the copper-bearing material. In some cases, the sand may be fine enough to skip the roll crusher step.

One of ordinary skill in the art would appreciate that the present invention provides systems and methods for processing waste materials to recover plastics and non-ferrous metals. Aspects of the invention employ density separation to separate plastic-bearing materials from copper-bearing materials. Plastic-bearing materials are further separated to separate light plastics from heavy plastics. Plastics are concentrated, extruded, and palletized. Copper and other valuable metals are recovered from copper-bearing materials using a water separation table.

What is claimed:

1. A method for recovering non-ferrous metal from a waste material, comprising the steps of:
(a) removing ferrous metals from the waste material;
(b) reducing the size of the waste material;
(c) introducing the size-reduced waste material onto a water separation table; and
(d) collecting concentrated non-ferrous metal from the water separation table.

2. The method of claim 1 further comprising the step of processing the waste material with an air separator to recover a light fraction, wherein the light fraction comprises waste material processed by steps (a)-(d).

3. The method of claim 2 further comprising the step of reducing the size of the waste material to approximately two inches or less before processing the waste material with the air separator.

4. The method of claim 2 further comprising the steps of:
recovering a heavy fraction from the air separator; and
recovering metal from the heavy fraction.

5. The method of claim 4 wherein the step of recovering metal from the heavy fraction comprises employing at least one of: sand flow separator, magnetic belt, inductive sensor, dynamic sensor, fluidized bed, and eddy current separator.

6. The method of claim 1 wherein the non-ferrous metal comprises copper.

7. The method of claim 6 further comprising the step of processing the collected non-ferrous metal to concentrate the copper.

8. The method of claim 7 wherein the step of processing the collected non-ferrous metal to concentrate the copper comprises identifying the non-copper material in the collected non-ferrous metal with a color sorter.

9. The method of claim 1 wherein the waste material comprises automobile shredder residue or whitegoods shredder residue.

10. The method of claim 1 further comprising the step of processing the waste material with a density separator to recover a heavy fraction, wherein the heavy fraction comprises waste material processed by steps (a)-(d).

11. The method of claim 10 wherein the step of processing the waste material with a density separator to recover a heavy fraction comprises employing at least one of: sink/float tank, sand flow separator, and hydrocyclone.

12. The method of claim 1 further comprising the step of processing the waste material with a dynamic sensor to generate a non-ferrous metal concentrate waste material, wherein non-ferrous metal concentrate waste material is processed by steps (a)-(d).

13. A system for recovering non-ferrous metal from a waste material comprising:
a ferrous metal subsystem, operable to remove ferrous metals from the waste material;
a size reducer, operable to reduce the size of the waste material prior to processing the waste material with a water separation table; and
the water separation table, operable to receive the size-reduced waste material from the size reducer and further operable to separate non-ferrous metal from the received material.

14. The system of claim 13 further comprising an air separator, operable to process the waste material to produce a light fraction of the waste material to be processed to separate non-ferrous metals.

15. The system of claim 14 further comprising at least one of: sand flow separator, magnetic belt, inductive sensor, dynamic sensor, fluidized bed, and eddy current separator, operable to separate non-ferrous metal comprising a heavy fraction of the waste material produced by the air separator.

16. The system of claim 13 wherein the non-ferrous metal comprises copper.

17. The system of claim 16 further comprising a color sorter operable to identify non-copper metals from the waste stream.

18. The system of claim 13 further comprising a density separator, operable to separate the waste material by density prior to introducing the material to the water separation table.

19. The system of claim 18 wherein the density separator comprises at least one of: sink/float tank, sand flow separator, and hydrocyclone.

20. The system of claim 13 wherein the waste material comprises automobile shredder residue or whitegoods shredder residue.

21. A method for recovering plastic from a waste material comprising the steps of:
(a) reducing the size of the constituents of the waste material;
(b) processing the ground waste material on a gravity table;
(c) recovering a heavy fraction from the gravity table;
(d) processing the recovered material using a hydrocyclone; and
(e) recovering the light fraction from the hydrocyclone comprising a plastic material.

22. The method of claim 21 wherein the step of processing the recovered material using a hydrocyclone comprises using a plurality of hydrocyclones.

23. The method of claim 21 further comprising the step of extruding and palletizing the plastic material.

24. The method of claim 23 wherein steps (a) through (e) of claim 20 comprise a batch process and the plastic material extruded comprises plastic material from a plurality of batches.

25. The method of step 23 further comprising the step of washing the plastic material prior to extruding the plastic material.

26. The method of claim 21 wherein the waste material comprises automobile shredder residue or whitegoods shredder residue.

27. The method of claim 21 further comprising the step of processing the waste material with a density separator to recover a light fraction, wherein the light fraction comprises waste material processed by steps (a)-(e).

28. The method of claim 27 wherein the step of processing the waste material with a density separator to recover a light fraction comprises employing at least one of: sink/float tank, sand flow separator, and hydrocyclone.

29. The method of claim 21 further comprising the step of processing the waste material with a rollback belt prior to step (b).

30. The method of claim 21 further comprising the step of processing the waste material with an x-ray sensor prior to step (b).

31. The method of claim 21 further comprising the step of processing the waste material with a thermal sorter prior to step (b).

32. The method of claim 21 further comprising the step of processing the waste material with a dielectric sensor prior to step (b).

33. A system for recovering plastic from a waste material comprising:
a size reducer;
a gravity table, operable to receive size-reduced waste material and concentrate a plastic fraction in the ground waste material; and
a hydrocyclone, operable to further concentrate the plastic fraction in the size-reduced waste material.

34. The system of claim 33 further comprising an extruder and a pelletizer, operable to extrude the concentrated plastic fraction and pelletize the extruded plastic.

35. The system of claim 33 wherein the hydrocyclone comprises a plurality of hydrocyclones.

36. The system of claim 33 wherein the waste material comprises automobile shredder residue or whitegoods shredder residue.

37. The system of claim 33 further comprising a rollback belt operable to remove rounded, light-weight material from the waste material.

38. The system of claim 33 further comprising an x-ray sensor operable to identify talc-filled polypropylene and glass-filled polypropylene.

39. The system of claim 33 further comprising at least one of: a thermal sorter and dielectric sensor, operable to identify non-plastic materials in the waste material.

40. The system of claim 33 further comprising a density separator, operable to separate the waste material by density prior to introducing the material to the gravity table.

41. The system of claim 40 wherein the density separator comprises at least one of: liquid sink/float tank, sand flow separator, and hydrocyclone.

42. A method for recovering materials from a waste stream comprising the steps of:
(a) separating the waste stream into a heavy fraction and a plastics fraction using a density separator, wherein the heavy fraction comprises copper and the plastics fraction comprises a light plastic fraction and a heavy plastic fraction;
(b) separating the light plastic fraction from the heavy plastic fraction;
(c) pelletizing the heavy plastic fraction; and
(d) concentrating the amount of copper in the heavy fraction using a water separation table.

43. The method of claim 42 further comprising the step of concentrating the amount of light plastic and the amount of heavy plastic in the plastics fraction prior to separating the light plastic from the heavy plastic.

44. The method of claim 43 wherein the step of concentrating the amount of light plastic and the amount of heavy plastic in the plastics fraction prior to separating the light plastic from the heavy plastic comprises employing at least one of: gravity table, rollback belt, x-ray sensor, thermal sensor, and dielectric sensor.

45. The method of claim 43 further comprising the step of removing non-copper material from the heavy fraction employing at least one of: air separator, sand flow separator, eddy current separator, inductive sensor, dynamic sensor, fluidized bed, and magnetic belt.

46. The method of claim 40 wherein the waste stream comprises automobile shredder residue or whitegoods shredder residue.
